(19) United States
(12) Patent Application Publication
(10) Pub. No.: US 2006/0232403 A1
(43) Pub. Date: Oct. 19, 2006

(54) Acoustic emission system and method for on-line measurement of glass break energy

(76) Inventors: Dieu-Hien X. Dang, Danville, KY (US); Zhiqiang Shi, Corning, NY (US)

Correspondence Address: CORNING INCORPORATED, SP-TI-3-1, CORNING, NY, 14831, US

(21) Appl. No.: 11/109,544

(22) Filed: Apr. 19, 2005

(51) Int. Cl. G08B 13/00

(52) U.S. Cl. 340/550

(57) ABSTRACT

An acoustic emission system and method are described herein that detect the glass break energy (or another parameter) that is created when a glass sheet is scored and broken. In the preferred embodiment, the acoustic emission system includes an acoustic emission sensor, a data acquisition system and a processor. The acoustic emission sensor interfaces with a glass sheet and generates an acoustic emission signal which is representative of acoustic emission waveforms that are created when the glass sheet was scored and broken. The data acquisition system records the acoustic emission signal. And, the processor processes the recorded acoustic emission signal to determine the glass break energy (or another parameter). Then, the processor can use the glass break energy (or another parameter) to determine the quality of an edge of the broken glass sheet. In addition, the processor can use the glass break energy (or another parameter) as feedback to adjust the scoring and breaking of subsequent glass sheets.

### BACKGROUND OF THE INVENTION

1. Field of the Invention

The present invention relates in general to the glass manufacturing field and, in particular, to an acoustic emission system and method that can detect the glass break energy (or another parameter) that is created when a glass sheet is scored and broken.

2. Description of Related Art

The scoring and breaking of a glass sheet to remove unwanted portions is a well established, reliable and economical process for sizing a glass sheet. To size the glass sheet, a score wheel is rolled with a predetermined force across the glass sheet which creates a crack within the glass sheet. The presence of this crack enables the glass sheet to be easily broken into the desired shape. However, there are numerous variables during the scoring and breaking process that can contribute to a poor score and cut edge quality. For instance, the score wheel may be worn or the score pressure may be too high or too low. As such, it would be desirable if one could optimize the scoring and breaking process to reduce the defects caused by a poor score and to improve the yield of properly sized glass sheets. This need and other needs are addressed by the present invention.

### BRIEF DESCRIPTION OF THE INVENTION

The present invention includes an acoustic emission system and method that detect the glass break energy (or another parameter) that is created when a glass sheet is scored and broken. In the preferred embodiment, the acoustic emission system includes an acoustic emission sensor, a data acquisition system and a processor. The acoustic emission sensor interfaces with a glass sheet and generates an acoustic emission signal which is representative of acoustic emission waveforms that are created when the glass sheet was scored and broken. The data acquisition system records the acoustic emission signal. And, the processor processes the recorded acoustic emission signal to determine the glass break energy (or another parameter). Then, the processor can use the glass break energy (or another parameter) to determine the quality of an edge of the broken glass sheet. In addition, the processor can use the glass break energy (or another parameter) as feedback to adjust the scoring and breaking of subsequent glass sheets.

### BRIEF DESCRIPTION OF THE DRAWINGS

A more complete understanding of the present invention may be had by reference to the following detailed description when taken in conjunction with the accompanying drawings wherein:

FIG. 1 is a block diagram of an acoustic emission system that is used to detect a glass break energy (or another parameter) that is created during the scoring and breaking of a glass sheet in accordance with the present invention;

FIG. 2 is a flowchart illustrating the basic steps of a method for detecting a glass break energy (or another parameter) that is created during the scoring and breaking of a glass sheet in accordance with the present invention;

FIG. 3 is a block diagram of an exemplary glass manufacturing system that can incorporate and use two different embodiments of the acoustic emission system while manufacturing a glass sheet in accordance with the present invention;

FIG. 4 is a block diagram illustrating the basic components of a first embodiment of the acoustic emission system in accordance with the present invention;

FIG. 5 is a block diagram illustrating the basic components of a second embodiment of the acoustic emission system in accordance with the present invention; and

FIGS. 6-9 are several diagrams that are used to help describe the results of three experiments that were conducted to demonstrate the functionality of the acoustic emission system shown in FIG. 5.

### DETAILED DESCRIPTION OF THE DRAWINGS

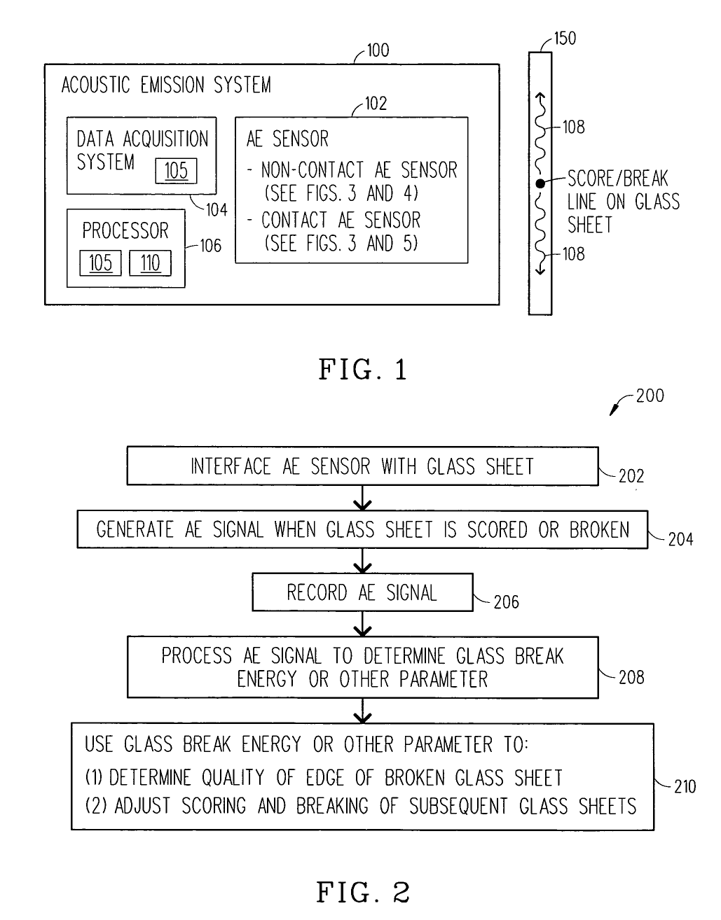

Referring to FIGS. 1 and 2, there are respectively illustrated a block diagram of an acoustic emission system 100 and a flowchart of a method 200 that can be used to detect the glass break energy (or another parameter) that is created during the scoring and breaking of a glass sheet 150. The acoustic emission system 100 includes one or more acoustic emission sensors 102, a data acquisition system 104 and a processor 106 (e.g., computer 106).

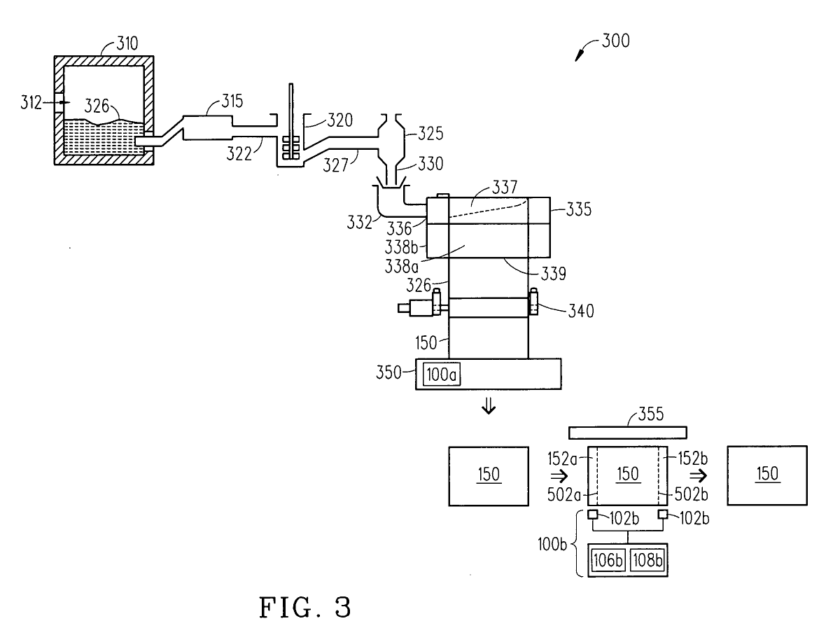

As shown in FIG. 1, the acoustic emission sensor 102 (one shown) is positioned such that it can interface with the glass sheet 150 (step 202 in FIG. 2). The acoustic emission sensor 102 generates and outputs one or more acoustic emission signals 105 which are representative of acoustic emission waveforms 108 that are created when the glass sheet 150 was scored and broken (step 204 in FIG. 2). In particular, the acoustic emission signals 105 are based on acoustic emission waveforms 108 which represent a spontaneous release of elastic energy in a form of wave propagation caused by the scoring and the breaking of the glass sheet 150. The data acquisition system 104 records the acoustic emission signals 105 (step 206 in FIG. 2). And, the processor 106 processes the recorded acoustic emission signals 105 to detect a glass break energy 110 (or another parameter) which was generated when the glass sheet 150 is scored and broken (step 208 in FIG. 2). Then, the processor 106 can use the measured glass break energy 110 (or another parameter) to determine a quality of an edge of the separated glass sheet 150 (step 210 in FIG. 2). In addition, the processor 106 can use the measured glass break energy 110 as feedback to adjust the scoring and breaking of subsequent glass sheets 150 (step 212 in FIG. 2). A detailed description about two different embodiments of the acoustic emission system 100 which are incorporated within an exemplary glass manufacturing system 300 is provided next with respect to FIGS. 3-5.

Referring to FIG. 3, there is shown a schematic view of the exemplary glass manufacturing system 300 that can incorporate and use two embodiments of the acoustic emission system 100a and 100b while making glass sheets 150. The glass manufacturing system 300 includes a melting vessel 310, a fining vessel 315, a mixing vessel 320 (e.g., stir chamber 320), a delivery vessel 325 (e.g., bowl 325), a forming vessel 335 (e.g., isopipe 335), a pull roll assembly 340, a horizontal scoring device 350, a vertical scoring device 355 and two different types of acoustic emission systems 100a and 100b.

As shown in FIG. 3, the melting vessel 310 is where the glass batch materials 312 are introduced and then melted to form molten glass 326. The fining vessel 315 (e.g., finer tube 315) has a high temperature processing area that receives the molten glass 326 (not shown at this point) from the melting vessel 310 and in which bubbles are removed from the molten glass 326. The fining vessel 315 is connected to the mixing vessel 320 (e.g., stir chamber 320) by a finer to stir chamber connecting tube 322. And, the mixing vessel 320 is connected to the delivery vessel 325 by a stir chamber to bowl connecting tube 327. The delivery vessel 325 delivers the molten glass 326 through a downcomer 330 to an inlet 332 and into the forming vessel 335 (e.g., isopipe 335).

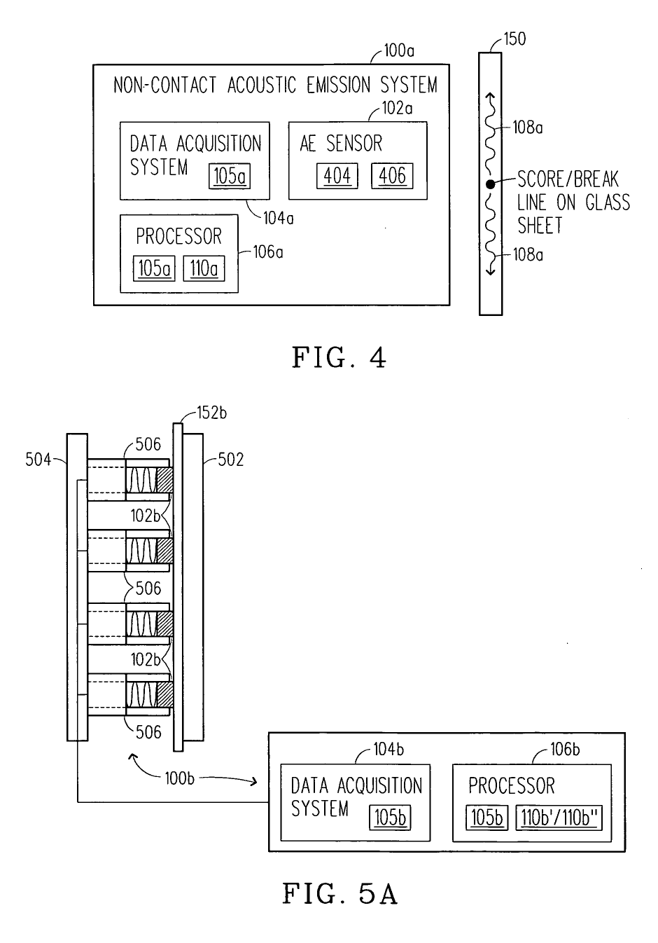

The forming vessel 335 includes an opening 336 that receives the molten glass 326 which flows into a trough 337 and then overflows the trough 337 and runs down two sides 338a and 338b before fusing together at what is known as a root 339. The root 339 is where the two sides 338a and 338b come together and where the two overflow walls of molten glass 326 rejoin (e.g., refuse) before being drawn downward by the pull roll assembly 340 to form the glass sheet 150. The scoring device 350 then horizontally scores and separates the drawn glass sheet 150 into distinct pieces of glass sheets 150. As the scoring device 350 horizontally scores and separates the drawn glass sheet 150, the first embodiment of the acoustic emission system 100a detects the glass break energy 110a (or another parameter) which is created as the glass sheet 150 is scored and separated. A detailed description about the acoustic emission system 100a is described next with respect to FIG. 4.

Referring to FIG. 4, there is a block diagram illustrating the basic components of the acoustic emission system 100a in accordance with the first embodiment of the present invention. The acoustic emission system 100a includes one or more acoustic emission sensors 102a, a data acquisition system 104a and a processor 106a (e.g., computer 106a). In this embodiment, the acoustic emission sensor 102a (one shown) does not physically contact the glass sheet 150. As can be seen, the non-contact acoustic emission sensor 102a is positioned such that it interfaces with the glass sheet 150 at a point located near to where the scoring device 350 is scoring and separating the drawn glass sheet 150. The non-contact acoustic emission sensor 102a is desirable since it is not affected by the high temperatures or vibrations which are common at this point in the glass manufacturing process. In the preferred embodiment, the non-contact acoustic emission sensor 102a is a laser interferometer which includes an optical probe 404 and a laser-ultrasonic detector 406. For instance, the non-contact acoustic emission sensor 102a can be a device made by TENCAR known as “Fabry-Perot Laser-Ultrasonic Detector” or it can be one of the devices that are manufactured by the Industrial Materials Institute (IMI) of the National Research Council of Canada (NRC) or by LASSON.

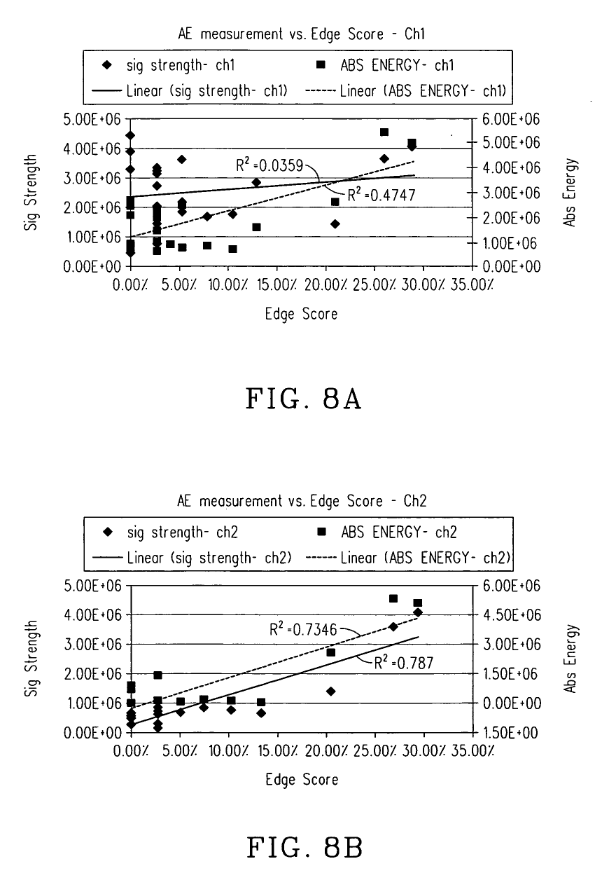

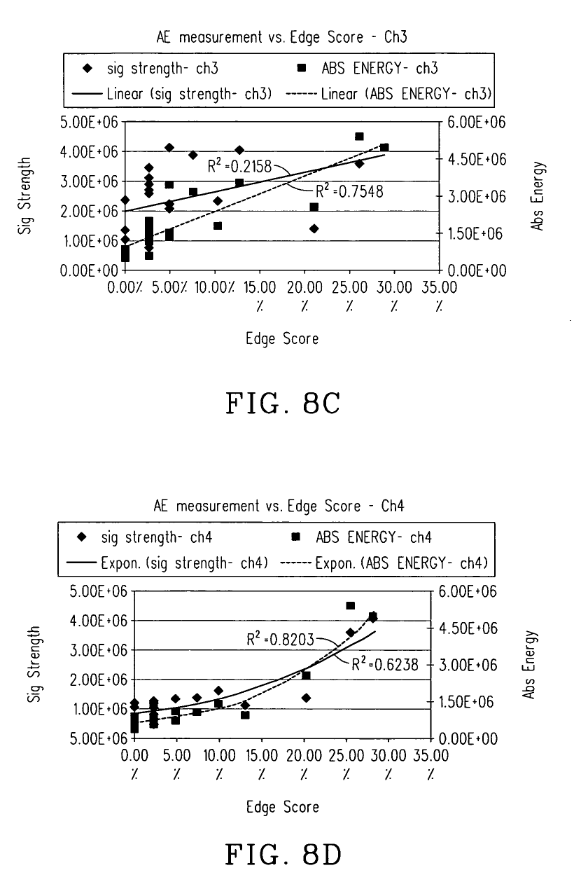

In operation, the acoustic emission sensor 102a generates and outputs one or more acoustic emission signals 105a that are based on acoustic emission waveforms 108a which are created when the glass sheet 150 is scored and broken. The data acquisition system 104a records the acoustic emission signals 105a. And, the processor 106a processes the acoustic emission signals 105a to determine a glass break energy 110a (or another parameter) which was created when the glass sheet 150 was scored and separated. The processor 106a can then use the measured glass break energy 110a (or another parameter) to determine a quality of an edge of the separated glass sheet 150 (e.g., see FIGS. 8A-8D). In addition, the processor 106a can use the glass break energy 110a (or another parameter) as feedback to adjust the scoring and breaking of subsequent glass sheets 150. For instance, the processor 106a can use the measured glass break energy 110a (or another parameter) as feedback to adjust the score pressure of a score wheel in the horizontal scoring device 350. And, the processor 106a can use the measured glass break energy 110a (or another parameter) to detect if the score wheel within the horizontal scoring device 350 is worn and needs to be replaced.

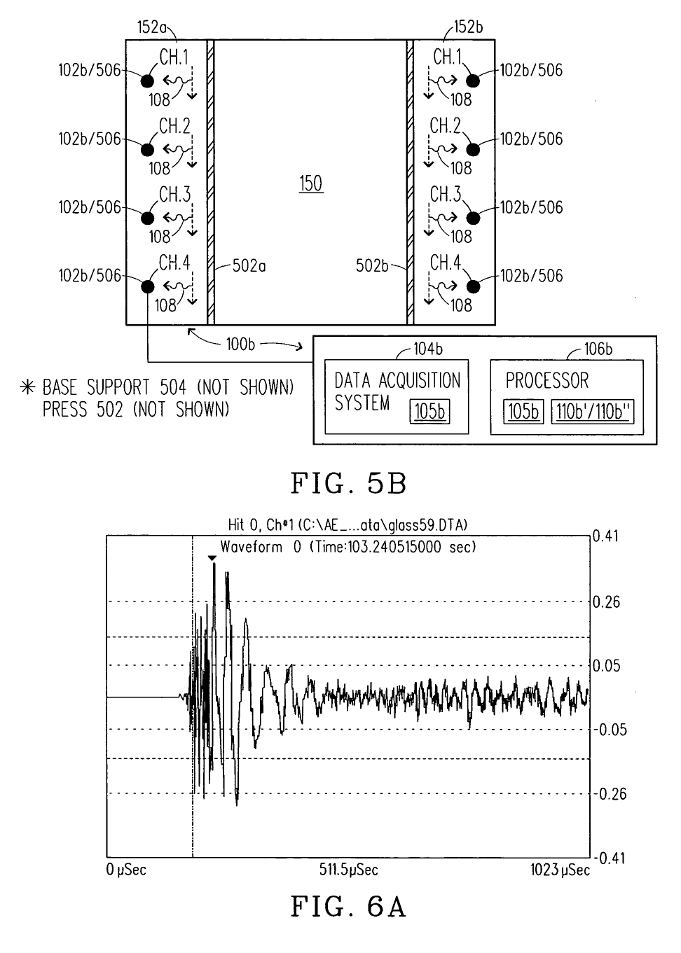

Referring again to FIG. 3, after the horizontally scoring device 350 scores and breaks the drawn glass sheet 150, then the cut glass sheet 150 is moved to another part of manufacturing process which has the vertical scoring device 355. The vertical scoring device 355 operates to vertically score and break-off two ends 152a and 152b from the glass sheet 150. As the vertical scoring device 355 scores and breaks the glass sheet 150, the second embodiment of the acoustic emission system 100b is used to detect the glass break energies 110b′ and 110b″ (or other parameters) that are created at both points 502a and 502b where the glass sheet 150 is scored and broken. A detailed description about the acoustic emission system 100b is described next with respect to FIGS. 5A and 5B.

Referring to FIGS. 5A and 5B, there are two diagrams illustrating the basic components of the acoustic emission system 100b in accordance with the second embodiment of the present invention. The acoustic emission system 100b includes one or more acoustic emission sensors 102b, a data acquisition system 104b and a processor 106b (e.g., computer 106b). In this embodiment, the acoustic emission sensors 102b (eight shown) physically contact the glass sheet 150 at two ends 152a and 152b which are going to be cut-off and removed by the vertical scoring device 355 (see FIG. 3). As can be seen in FIG. 5A, end 152b of the glass sheet 150 is located between a press 502 and four of the acoustic emission sensors 102b that are attached to a base support 504 (the same is true for end 152a). Each acoustic emission sensor 102b can be supported by a spring loaded fixture 506. And, each spring loaded fixture 506 provides a consistent contact between the interface of the glass sheet 150 and the acoustic emission sensor 102b. In the preferred embodiment, the acoustic emission sensor 102b is a piezoelectric transducer that is capable of making modal acoustic emission measurements. For instance, the acoustic emission sensor 102b can be a device made by DIGITAL WAVE known as “The B1025 Series Sensor”.

In operation, the acoustic emission sensor 102b generates and outputs one or more acoustic emission signals 105b that are based on acoustic emission waveforms 108b which are created when the glass sheet 150 is scored and broken. The data acquisition system 104b records the acoustic emission signals 105b. And, the processor 106b processes the acoustic emission signals 105b to determine the glass break energies 110b′ and 110b″ (or other parameters) respectively generated at both points 502a and 502b on the glass sheet 150 when the ends 152a and 152b are scored and separated. The processor 106b can then use the measured glass break energies 110b′ and 110b″ to determine the qualities of the edges of the separated glass sheet 150 (e.g., see FIGS. 8A-8D). The processor 106b can also use the glass break energies 110b′ and 110b″ as feedback to adjust the scoring and breaking of subsequent glass sheets 150. For instance, the processor 106b can use the measured glass break energies 110b′ and 110b″ as feedback to adjust the score pressures on score wheels in the vertical scoring device 355. And, the processor 106b can use the measured glass break energies 110b′ and 110b″ to detect if any of the score wheels within the vertical scoring device 355 are worn and need to be replaced.

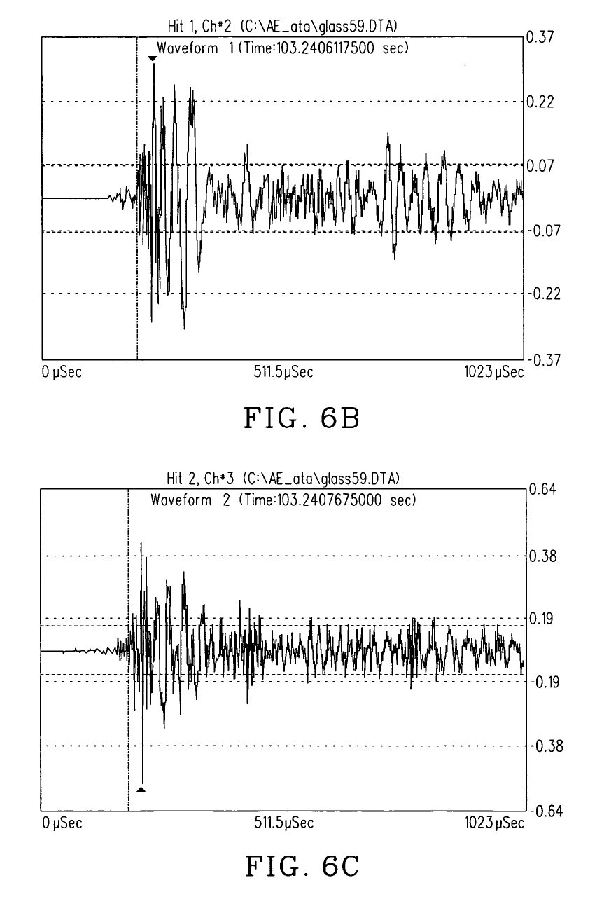

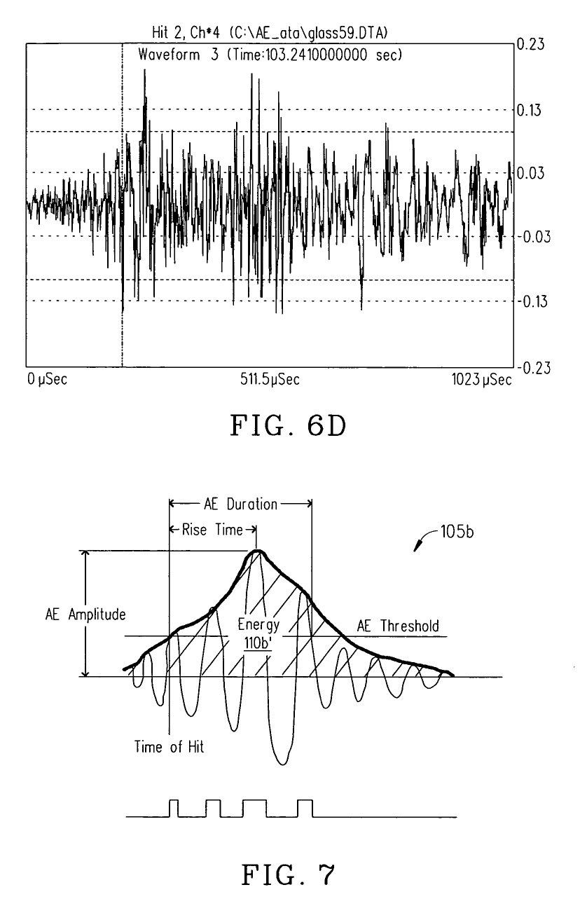

A discussion is provided next to describe the results of three experiments that were conducted to test the second embodiment of the acoustic emission control system 100b. In one experiment, four acoustic emission sensors 102b were mounted with the aid of spring-located fixtures 506 onto the end 152b (inlet end 152b) of the glass sheet 150 (see FIGS. 5A and 5B). The four acoustic emission sensors 102b are identified as channels 1, 2, 3 and 4. The vertical scoring device 355 was then used to score and separate end 152b from the glass sheet 150. During the separation process, the data acquisition system 104b received four acoustic emission signals 105b from four acoustic emission sensors 102b. The four acoustic emission signals 105b are shown in FIGS. 6A-6D.

The processor 106b analyzed the four acoustic emission signals 105b and determined four different glass break energies 110b″ which happen to be only one of many parameters/features in the acoustic emission signals 105b. FIG. 7 indicates some of the other features/parameters of an “exemplary” acoustic emission signal 105b that can be measured by the processor 106b. These features/parameters include:
Time of detection.
Channel count.
Signal strength.
Absolute energy (glass break energy 110b″).
Amplitude.
Energy.
Count.
Duration.
Average frequency.
Rise time.
Count-to-peak.

In another experiment, the acoustic emission control system 100b was used to determine the “absolute energies” (glass break energies 110b′) and the “signal strengths” of four different acoustic emission signals 105b that were output by four different acoustic emission sensors 102b. The processor 106b correlated each pair of the “absolute energies” and “signal strengths” to determine a quality of the edge of the cut glass sheet 150 (see FIGS. 8A-8D). In these graphs, it should be noted that the higher the edge score is then the larger number of defects there were on the cut edge of the glass sheet 150.

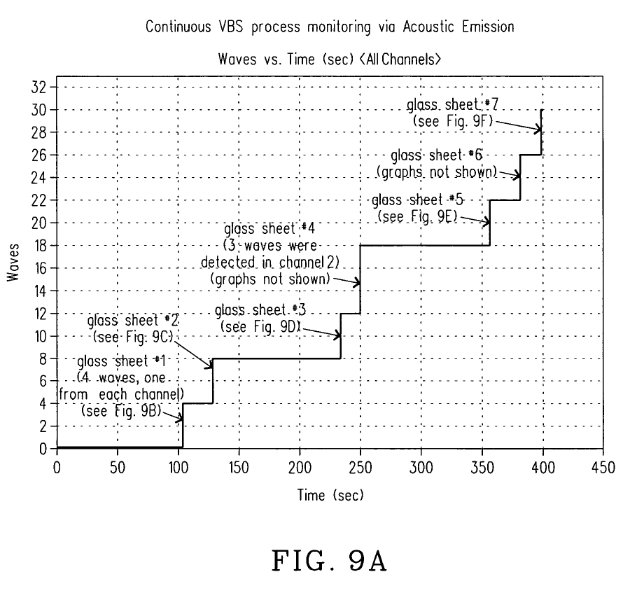

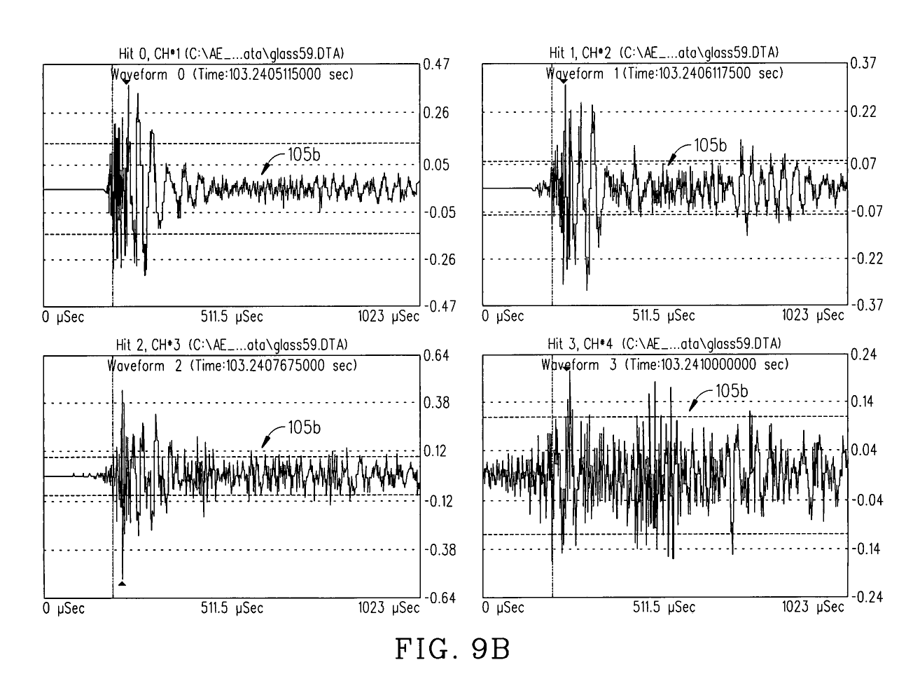

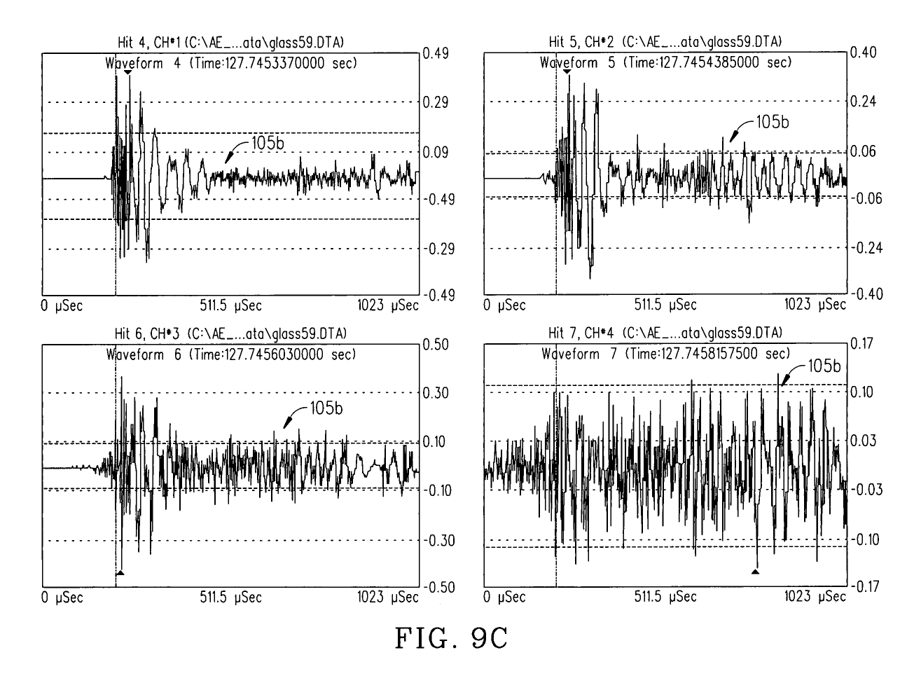

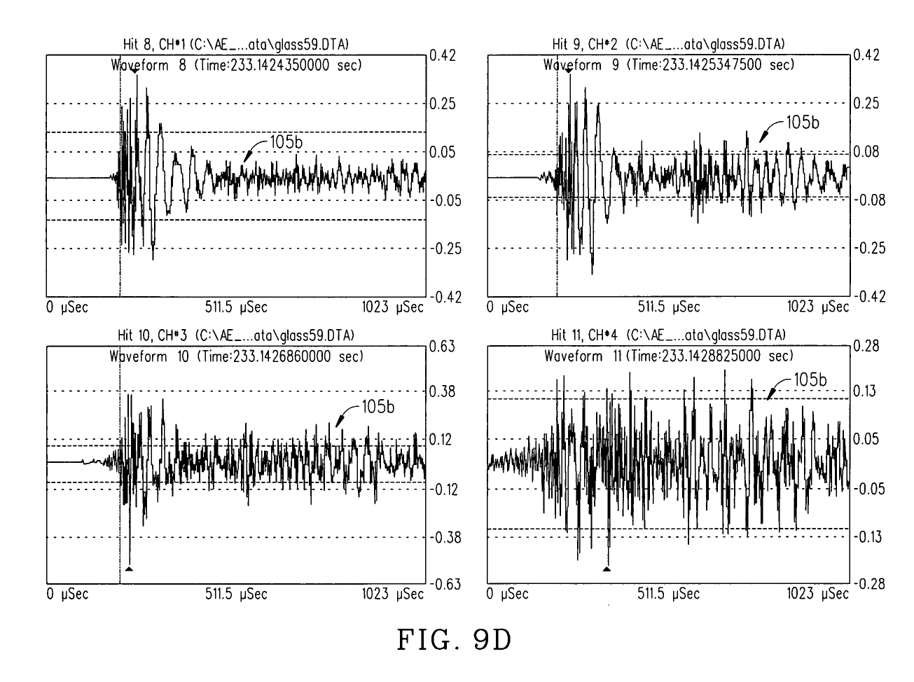

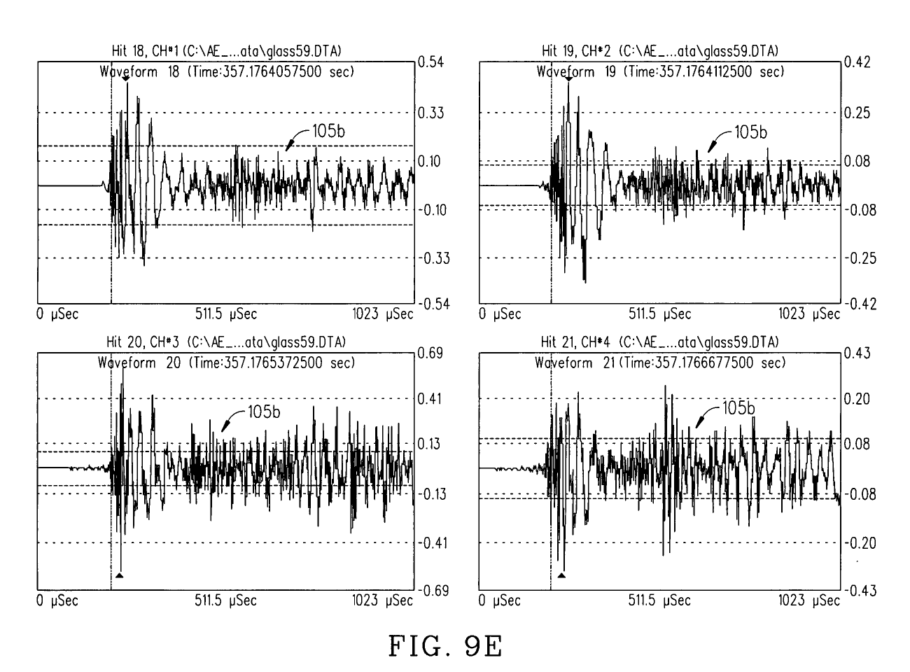

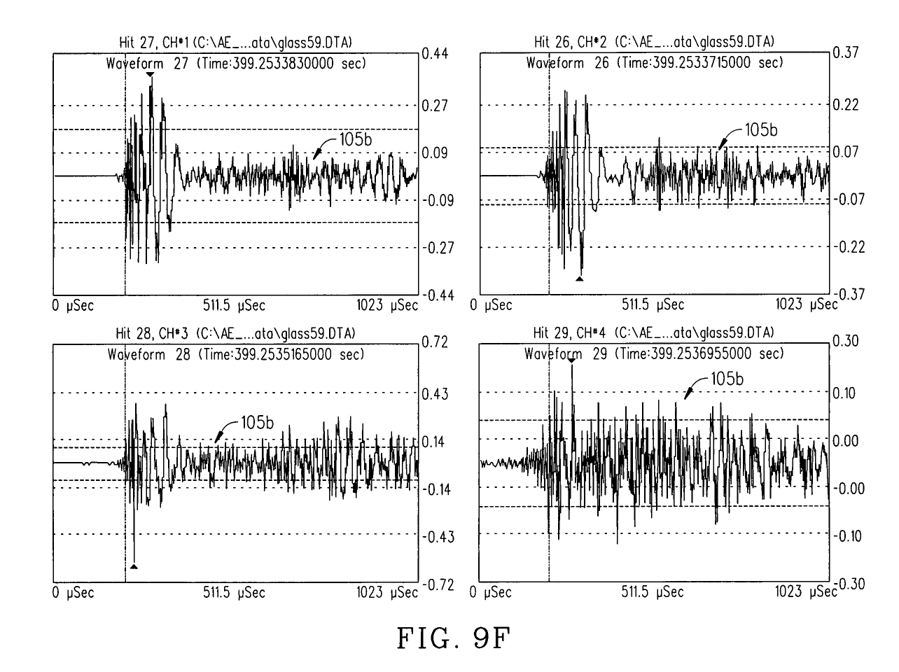

In still yet another experiment, the acoustic emission control system 100b was used to continuously monitor in real-time and on-line the scoring/breaking process of seven consecutive glass sheets 150. In particular, the acoustic emission control system 100b output a series of acoustic emission signals 105b that were generated during the scoring of seven different glass sheets 150 (see FIGS. 9A-9F). As described above, this data associated with the different acoustic emission signals 105b can be used as feedback to improve the scoring and cutting process of subsequent glass sheets 150. It should be noted that the units in the y-axis of FIGS. 9B-9F are relative since the signal is a voltage output and can be arbitrarily amplified. This is also true for the y-axis in the graphs of FIGS. 6A-6D.

Following are some features, advantages and uses of the present invention:
The acoustic emission system 100 enables the real-time online monitoring of glass edge quality.
The acoustic emission system 100 can accurately detect the acoustic signature of glass separation in real-time and online.
The acoustic emission system 100 can utilize a broadband filter (preferred) or a narrowband filter to process the acoustic emission signal 105.
It should be appreciated that the non-contact acoustic emission system 100a can be used instead of the contact acoustic emission system 100b to detect the glass break energies (or other parameters) that are created by the vertical scoring device 355.
It should be appreciated that the glass manufacturing system 300 is exemplary and that other types and configurations of glass manufacturing systems can incorporate and use the acoustic emission system 100 and method 200 of the present invention.
For a more detailed discussion about the glass manufacturing system 300 that produces glass sheets 150 using the fusion process, reference is made to U.S. Pat. Nos. 3,338,696 and 3,682,609. The contents of these patents are incorporated herein by reference.

Although two embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A system comprising:
an acoustic emission (AE) sensor capable of interfacing with a glass sheet;
said AE sensor further capable of generating an AE signal that is based on AE waveforms which are created when the glass sheet is scored and borken;
a data acquisition system capable of recording the AE signal; and
a processor capable of processing the recorded AE signal to obtain a glass break energy or another feature of the recorded AE signal.

2. The system of claim 1, wherein said AE sensor physically contacts the glass sheet while the glass sheet is being scored and broken.

3. The system of claim 2, wherein said AE sensor is a piezoelectric transducer.

4. The system of claim 2, further comprising a spring loaded fixture capable of supporting said AE sensor.

5. The system of claim 1, wherein said AE sensor does not physically contact the glass sheet while the glass sheet is being scored and broken.

6. The system of claim 5, wherein said AE sensor is a non-contact laser interferometer.

7. The system of claim 6, wherein said non-contact laser interferometer includes an optical probe and a laser-ultrasonic detector.

8. The system of claim 1, wherein said processor is further capable of processing the glass break energy or another feature of the recorded AE signal to determine a quality of an edge of the broken glass sheet.

9. The system of claim 1, wherein said measured glass break energy is used as feedback to adjust the scoring and breaking of subsequent glass sheets.

10. The system of claim 1, wherein said AE signal is based on the AE waveforms which represent a spontaneous release of elastic energy in a form of wave propagation that is caused by the scoring and the breaking of the glass sheet.

11. The system of claim 1, wherein said AE signal is processed by a broadband filter.

12. The system of claim 1, wherein said AE signal is processed by a narrowband filter.

13. The system of claim 1, wherein each AE signal includes the glass break energy and the following parameters:
a time of detection;
a channel count;
a signal strength;
an amplitude;
an energy;
a count
a duration;
an average frequency;
a rise time; and
a count-to-peak.

14. A method for obtaining information related to scoring and breaking of a glass sheet, said method comprising the steps of:
interfacing an acoustic emission (AE) sensor with a glass sheet;
generating an AE signal when the AE sensor senses AE waveforms that are created while scoring and breaking the glass sheet;
recording the AE signal; and
processing the recorded AE signal to determine a glass break energy or another feature of the recorded AE signal.

15. The method of claim 14, wherein said step of interfacing includes physically connecting the AE sensor to the glass sheet when the glass sheet is scored and broken.

16. The method of claim 15, wherein said AE sensor is a piezoelectric transducer.

17. The method of claim 14, wherein said step of interfacing includes physically separating the AE sensor from the glass sheet when the glass sheet is being scored and broken.

18. The method of claim 17, wherein said AE sensor is a non-contact laser interferometer that includes an optical probe and a laser-ultrasonic detector.

19. The method of claim 14, further comprising the step of processing the glass break energy or another feature of the recorded AE signal to determine a quality of an edge of the broken glass sheet.

20. The method of claim 14, further comprising the step of using the measured glass break energy as feedback to adjust the scoring and breaking of subsequent glass sheets.

21. A glass manufacturing system comprising:
at least one vessel for melting batch materials and forming molten glass;
a forming apparatus for receiving the molten glass and forming a glass sheet;
a pulling machine for drawing the glass sheet;
a first cutting machine for horizontally cutting and breaking the glass sheet;
a first acoustic emission (AE) system comprising:
a first AE sensor capable of interfacing with a glass sheet and capable of generating a first AE signal based on acoustic emission waveforms which are created while horizontally cutting and breaking the glass sheet;
a data acquisition system capable of recording the first AE signal; and
a processor capable of processing the recorded first AE signal to obtain a first glass break energy or another feature of the recorded first AE signal;
a second cutting machine for vertically cutting and breaking the previously cut glass sheet; and
a second AE system comprising:
a second AE sensor capable of interfacing with the glass sheet and capable of generating a second AE signal based on acoustic emission waveforms which are created while vertically cutting and breaking the glass sheet;
a data acquisition system capable of recording the second AE signal; and
a processor capable of processing the recorded second AE signal to detect a second glass break energy or another feature of the recorded second AE signal.

22. The glass manufacturing system of claim 21, wherein said first AE sensor does not physically contact the glass sheet while the glass sheet is being cut and broken.

23. The glass manufacturing system of claim 21, wherein said second AE sensor physically contacts the glass sheet while the glass sheet is being cut and broken.

24. The glass manufacturing system of claim 21, wherein said at least one of the first glass break energy, the second glass break energy and the other features of the first and second AE signals is used to determine a quality of at least one edge of the broken glass sheet.

25. The glass manufacturing system of claim 21, wherein said at least one of the first glass break energy, the second glass break energy and the other features of the first and second AE signals is used to adjust the cutting and breaking of subsequent glass sheets.

26. A method for producing a glass sheet, said method comprising the steps of:
melting batch materials to form molten glass;
processing the molten glass to form the glass sheet;
drawing the glass sheet;
horizontally cutting and breaking the drawn glass sheet;
using a first acoustic emission (AE) system which performs the following steps:
interfacing a first AE sensor with the glass sheet;
generating a first AE signal when the first AE sensor senses AE waveforms that are created while horizontally cutting and breaking the glass sheet;
recording the first AE signal; and
processing the recorded first AE signal to detect a first glass break energy or another feature in the first AE signal;
vertically cutting and breaking the previously cut glass sheet; and
using a second AE system which performs the following steps:
interfacing a second AE sensor with the glass sheet;
generating a second AE signal when the second AE sensor senses AE waveforms that are created while vertically cutting and breaking the glass sheet;
recording the second AE signal; and
processing the recorded second AE signal to detect a second glass break energy or another feature of the second AE signal.

27. The method of claim 26, wherein said first AE sensor does not physically contact the glass sheet while the glass sheet is being cut and broken.

28. The method of claim 26, wherein said second AE sensor physically contacts the glass sheet while the glass sheet is being cut and broken.

29. The method of claim 26, further comprising the step of using at least one of the first glass break energy, the second glass break energy and the other features of the first and second AE signals to determine a quality of the at least one edge of the broken glass sheet.

30. The method of claim 26, further comprising the step of using at least one of the first glass break energy, the second glass break energy and the other features of the first and second AE signals to adjust the cutting and breaking of subsequent glass sheets.
